(19) United States
(12) Patent Application Publication
(10) Pub. No.: US 2024/0212702 A1
(43) Pub. Date: Jun. 27, 2024

(54) MANUAL-ENROLLMENT-FREE PERSONALIZED DENOISE

(71) Applicant: Zoom Video Communications, Inc., San Jose, CA (US)

(72) Inventors: Jiachuan Deng, Singapore (SG); Cheng Lun Hu, Singapore (SG); Zhaofeng Jia, Saratoga, CA (US); Qiyong Liu, Singapore (SG); Zhengwei Wei, Singapore (SG); Da-Yi Wu, Singapore (SG)

(21) Appl. No.: 18/088,070

(22) Filed: Dec. 23, 2022

(51) Int. Cl. G10L 21/0232; G10L 17/02

(52) U.S. Cl. CPC G10L 21/0232; G10L 17/02; G10L 25/18

(57) ABSTRACT

Various embodiments of an apparatus, method(s), system(s) and computer program product(s) described herein are directed to a Denoise Engine. The Denoise Engine collects segments of voice content of a first user account from audio data associated with a virtual meeting. The audio data further includes additional types of audio content. The Denoise Engine identifies an audio embedding model. The Denoise Engine receives a speaker embedding generated by the audio embedding model. The speaker embedding based on the collected segments of voice content. The Denoise Engine generates personalized denoised voice content of the first user account for the virtual meeting by applying the speaker embedding to the audio data associated with a virtual meeting.

### FIELD

Various embodiments relate generally to digital communication, and more particularly, to online video and audio.

### SUMMARY

The appended Abstract may serve as a summary of this application.

### BRIEF DESCRIPTION OF THE DRAWINGS

The present disclosure will become better understood from the detailed description and the drawings, wherein:

FIG. 1A is a diagram illustrating an exemplary environment in which some embodiments may operate.

FIG. 1B is a diagram illustrating an exemplary environment in which some embodiments may operate.

FIG. 2 is a diagram illustrating an exemplary environment in which some embodiments may operate.

FIG. 3 is a diagram illustrating an exemplary environment in which some embodiments may operate.

FIG. 4 is a diagram illustrating an exemplary flowchart according to some embodiments.

FIG. 5 is a diagram illustrating an exemplary environment in which some embodiments may operate.

FIG. 6 is a diagram illustrating an exemplary environment in which some embodiments may operate.

FIG. 7 is a diagram illustrating an exemplary environment in which some embodiments may operate.

### DETAILED DESCRIPTION OF THE DRAWINGS

Various embodiments of a Denoise Engine are described herein that provide functionality for generating denoised audio content based on features of voice content of a specific user account. The Denoise Engine collects and filters voice content of a particular user account and generates denoised voice content specific to that user account. For example, the Denoise Engine generates personalized denoised voice content when the audio input from the user account may have initially included audio content representing ambient audio interference, such as one or more speakers located physically near the individual that corresponds with the user account.

According to one or more embodiments, an individual may access a virtual meeting via a first user account. Audio data associated with the virtual meeting may include voice content of the first user account and additional audio content. The Denoise Engine collects respective segments of the voice content specific to the first user account and discards other types of audio content.

The Denoise Engine generates embedded versions of the segments of the voice content of the first user account. Upon generating the voice content segment embeddings, the Denoise Engine may filter the voice content segment embeddings according to a segment similarity criterion. The Denoise Engine groups respective voice content segment embeddings that satisfy the segment similarity criteria and determines an average embedding based on the grouped segments. The Denoise Engine feeds the average embedding of the first user account's voice content and the original input audio into a personalized denoise model. The personalized denoise model returns output representing denoised audio output.

In some embodiments, the Denoise Engine may determine that buffered voice content represented audio interference based on high-quality audio data from the first user account's voice content and high-quality audio data from one or more background speakers represented in ambient audio data. Based on presence of high-quality audio interference, the Denoise Engine determines that a condition has been satisfied to bypass use of the personalized denoise model altogether.

Various embodiments of an apparatus, method(s), system(s) and computer program product(s) described herein are directed to a Denoise Engine. The Denoise Engine collects segments of voice content of a first user account from audio data associated with a virtual meeting. The audio data further includes additional types of audio content. The Denoise Engine identifies an audio embedding model. The Denoise Engine receives a speaker embedding generated by the audio embedding model. The speaker embedding based on the collected segments of voice content; The Denoise Engine generates personalized denoised voice content of the first user account for the virtual meeting by applying the speaker embedding to the audio data associated with a virtual meeting.

In some embodiments, the Denoise Engine determines whether to feed speaker embedding and the virtual meeting audio data into the personalized denoise model based on determining presence high-quality voice content data that corresponds to single speaker has been collected.

In some embodiments, the Denoise Engine bypasses the personalized denoise model based on determining presence of high-quality voice content data that corresponding to multiple speakers has been collected.

In some embodiments, an instance of the personalized denoise model may be implemented local to a computer device associated with a user account (such as the first user account). Each user account may be associated with a different computer device.

In some embodiments, a each user account from a plurality of user accounts is associated with the same speaker embedding and audio embedding model, which is fed into a locally-implemented personalized denoise model. The same personalized denoise model may be implemented for each user account as well.

In one or more embodiments, the Denoise Engine enforces a requirement that voice content of the first user account must be captured at a particular type(s) of audio capture device in order for the voice content of the first user account to qualify for being collected for generating personalized denoised audio output.

According to one or more embodiments, the Denoise Engine may be directed to generating denoised audio for a plurality of selected user accounts. For example, a virtual meeting may be currently accessed by multiple user accounts. The Denoise Engine may receive a selection of a subset of those user accounts and identifies a different audio embedding model specific to each user account in the selected subset. The Denoise Engine collects, isolates and filters voice segments of each of the user accounts identified in the subset and thereby generates audio embeddings for each user account in the selected subgroup. The Denoise Engine thereby concurrently generates personalized denoised audio output based on the voice segment embeddings of two or more user accounts. In some embodiments, each user account in the selected subgroup may be associated with its own particular audio embedding model and personalized denoise model.

In one or more embodiments, the Denoise Engine may collect voice segments in received input audio for each respective user account in a plurality of user accounts. The Denoise Engine may store the collected voice segments. The Denoise Engine further generates personalized denoised audio output for one of the user accounts, such as a first user account. During generation of the personalized denoised audio output for a first user account, the Denoise Engine receives a selection of a second user account. The Denoise Engine may switch over to generating personalized denoised audio based on the collected and stored second user account's previously stored voice segments and/or subsequent voice segments of the second user account collected after switching over to the second user account.

In other embodiments, the Denoise Engine may continue generating personalized denoised audio output for a first user account and initiate concurrent generation of personalized denoised audio output for a second user account by accessing stored voice segments of the second user account. For example, the Denoise Engine may detect that the second user account may change between use of different audio capture devices during the virtual meeting. The Denoise Engine may initiate generating personalized denoised audio output for the second user account in response to determining the new audio capture device now in use by the individual that corresponds with the second user account is a specific type of preferred audio capture device, such as a headset device.

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the invention. The invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

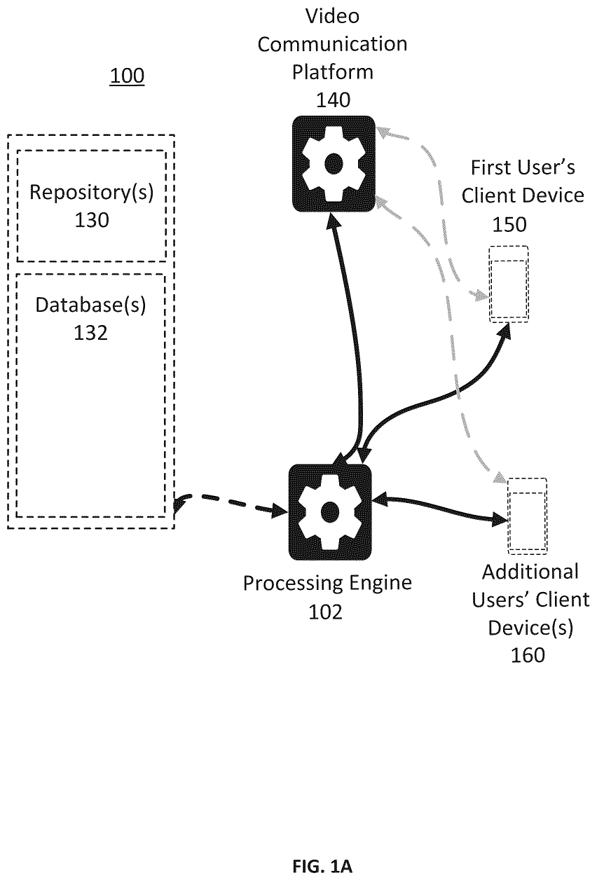

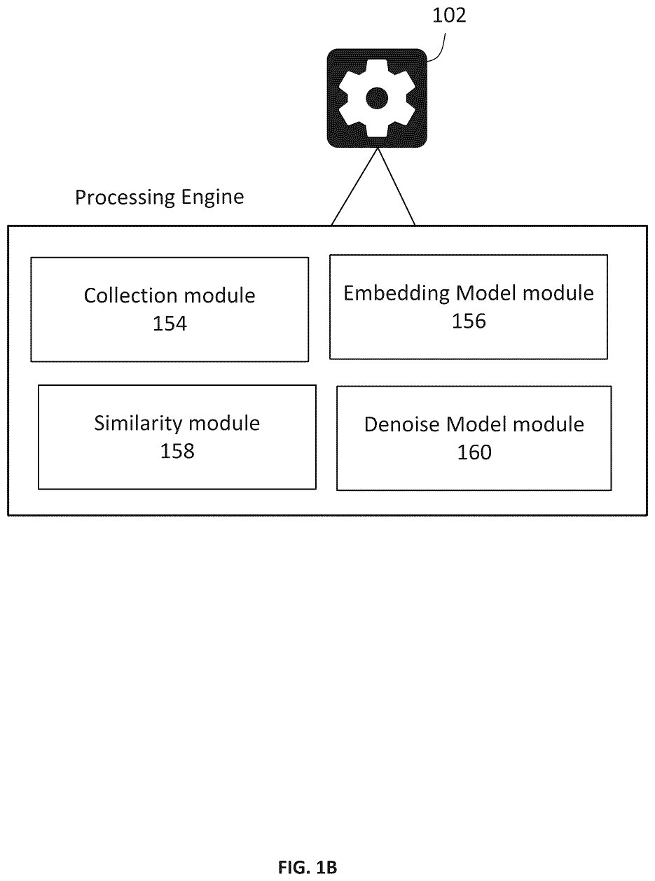

FIG. 1A is a diagram illustrating an exemplary environment in which some embodiments may operate. In the exemplary environment 100, a sending client device 150, one or more receiving client device(s) 160 are connected to a processing engine 102 and, optionally, a communication platform 140. The processing engine 102 is connected to the communication platform 140, and optionally connected to one or more repositories 130 and/or databases 132. One or more of the databases may be combined or split into multiple databases. The sending client device 150 and receiving client device(s) 160 in this environment may be computers, and the communication platform server 140 and processing engine 102 may be applications or software hosted on a computer or multiple computers which are communicatively coupled via remote server or locally.

The exemplary environment 100 is illustrated with only one sending client device, one receiving client device, one processing engine, and one communication platform, though in practice there may be more or fewer sending client devices, receiving client devices, processing engines, and/or communication platforms. In some embodiments, the sending client device, receiving client device, processing engine, and/or communication platform may be part of the same computer or device.

In an embodiment(s), the processing engine 102 may perform methods disclosed herein or other method herein. In some embodiments, this may be accomplished via communication with the sending client device, receiving client device(s), processing engine 102, communication platform 140, and/or other device(s) over a network between the device(s) and an application server or some other network server. In some embodiments, the processing engine 102 is an application, browser extension, or other piece of software hosted on a computer or similar device or is itself a computer or similar device configured to host an application, browser extension, or other piece of software to perform some of the methods and embodiments herein.

Sending client device 150 and receiving client device(s) 160 are devices with a display configured to present information to a user of the device. In some embodiments, the sending client device 150 and receiving client device(s) 160 present information in the form of a user interface (UI) with UI elements or components. In some embodiments, the sending client device 150 and receiving client device(s) 160 send and receive signals and/or information to the processing engine 102 and/or communication platform 140. The sending client device 150 is configured to submit messages (i.e., chat messages, content, files, documents, media, or other forms of information or data) to one or more receiving client device(s) 160. The receiving client device(s) 160 are configured to provide access to such messages to permitted users within an expiration time window. In some embodiments, sending client device 150 and receiving client device(s) are computer devices capable of hosting and executing one or more applications or other programs capable of sending and/or receiving information. In some embodiments, the sending client device 150 and/or receiving client device(s) 160 may be a computer desktop or laptop, mobile phone, virtual assistant, virtual reality or augmented reality device, wearable, or any other suitable device capable of sending and receiving information. In some embodiments, the processing engine 102 and/or communication platform 140 may be hosted in whole or in part as an application or web service executed on the sending client device 150 and/or receiving client device(s) 160. In some embodiments, one or more of the communication platform 140, processing engine 102, and sending client device 150 or receiving client device 160 may be the same device. In some embodiments, the sending client device 150 is associated with a sending user account, and the receiving client device(s) 160 are associated with receiving user account(s).

In some embodiments, optional repositories function to store and/or maintain, respectively, user account information associated with the communication platform 140, conversations between two or more user accounts of the communication platform 140, and sensitive messages (which may include sensitive documents, media, or files) which are contained via the processing engine 102. The optional repositories may also store and/or maintain any other suitable information for the processing engine 102 or communication platform 140 to perform elements of the methods and systems herein. In some embodiments, the optional database(s) can be queried by one or more components of system 100 (e.g., by the processing engine 102), and specific stored data in the database(s) can be retrieved.

Communication platform 140 is a platform configured to facilitate communication between two or more parties, such as within a conversation, “chat” (i.e., a chat room or series of public or private chat messages), video conference or meeting, message board or forum, virtual meeting, or other form of digital communication. In some embodiments, the platform 140 may further be associated with a video communication environment and a video communication environment client application executed on one or more computer systems.

FIG. 1B is a diagram illustrating exemplary software modules 154, 156, 158, 160 of a Denoise Engine that may execute at least some of the functionality described herein. According to some embodiments, one or more of exemplary software modules 154, 156, 158, 160 may be part of the processing engine 102. In some embodiments, one or more of the exemplary software modules 154, 156, 158, 160 may be distributed throughout the communication platform 140.

The module 154 functions to collect and discard one or more segments of input audio. Module 154 may also implement a quality assessment and placing one or more segments of input audio into a buffer.

The module 156 functions to implement an audio embedding model specific to one or more user accounts.

The module 158 functions to implement a similarity check for determining a similarity between respective segments of input audio.

The module 160 functions to implement a personalized denoise model specific to one or more user accounts.

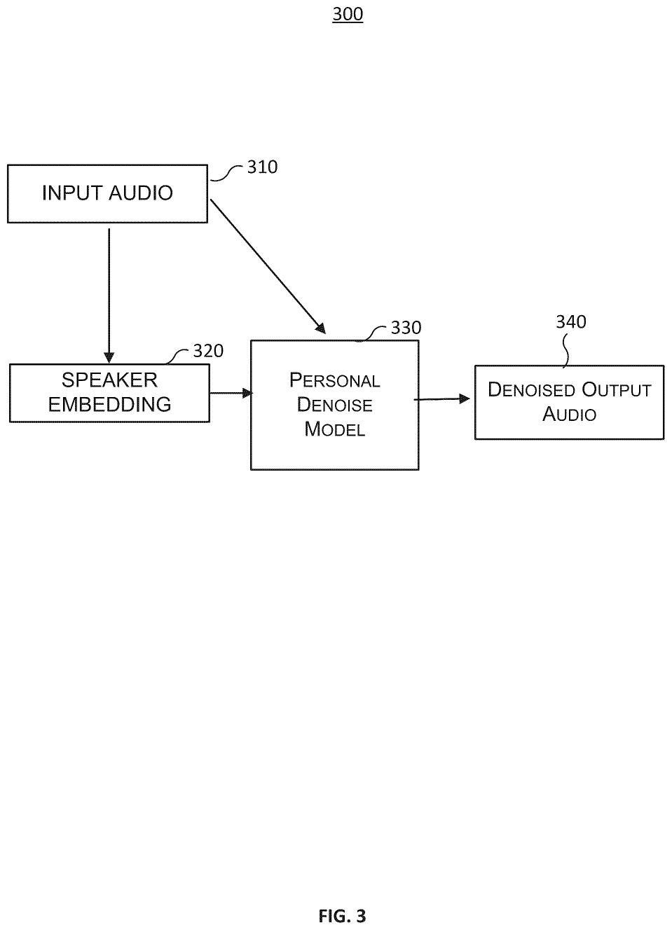

The above modules 154, 156, 158, 160 and their functions will be described in further detail in relation to FIGS. 3, 4, 5 and 6.

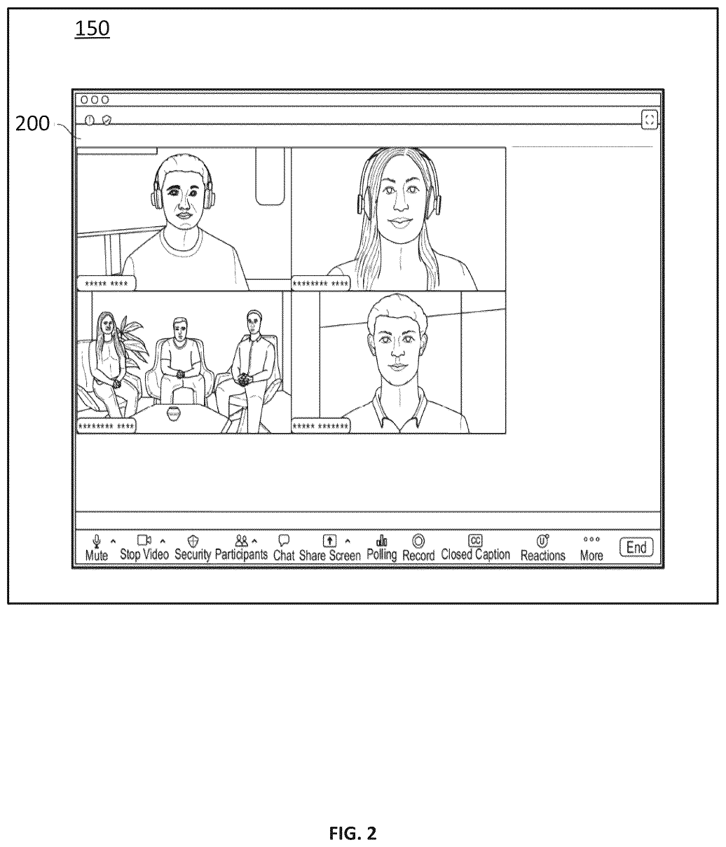

As shown in the example of FIG. 2, a user account communications interface 200 for accessing and communicating with the platform 140 and displayed at a computer device 150. The interface 200 provides access to video data, audio data, chat data and meeting transcription related to an online event(s), such as a virtual webinar or a virtual meeting joined by a user account associated with the computer device 150. The interface 200 further provides various types of tools, functionalities, and settings that can be selected by a user account during an online event. Various types of virtual meeting control tools, functionalities, and settings are, for example, mute/unmute audio, turn on/off video, start meeting, join meeting, view and call contacts.

As shown in diagram 300 of the example of FIG. 3, the Denoise Engine receives input audio 310 based on audio data associated with a virtual meeting. For example, the virtual meeting may be accessed by multiple user accounts. One or more of the user accounts may be providing audio content to the virtual meeting. The input audio 310 may include various types of audio content, such as voice content from different user accounts and other types of audio content (i.e. music, ambient noise, audio interference, background speakers, etc.).

The Denoise Engine generates a speaker embedding 320 representing embedded versions of respective segments of voice content of a first user account. The Denoise Engine collects segments of voice content from a first user account and generates embedded versions 320 of at least some of the collected voice content segments (i.e. speaker embeddings). The Denoise Engine feeds at least a portion of the embedded versions 320 of the collected voice content segments and the input audio 310 into a personalized denoise model 330.

The personalized denoise model 330 generates denoised audio output 340. The denoised audio output 340 may be audio output specific to the first user account, regardless of the input audio from other user accounts and other types of audio content occurring in the virtual meeting or capable of being perceived via audio of the virtual meeting (such as interference audio). According to various embodiments, the personalized denoise model 330 implements various artificial intelligence and/or machine learning techniques.

While the same audio embedding model may be implemented for each user account from a plurality of user accounts, the audio embedding model returns a speaker embedding for each respective user account. That is, a first speaker embedding returned for a first user account will be specific to the first user account and a second speaker embedding returned for a second user account will be specific to the second user account. The same personalized denoise model 330 may also be implemented for each user account from the plurality of user accounts. When the personalized denoise model 330 receives a speaker embedding 320 for the first user account, the personalized denoise model 330 utilizes the first user account's speaker embedding 320 to preserve voice content of the first user account. Similarly, when the personalized denoise model 330 receives a speaker embedding for the second user account, the personalized denoise model 330 utilizes the second user account's speaker embedding to preserve voice content of the second user account.

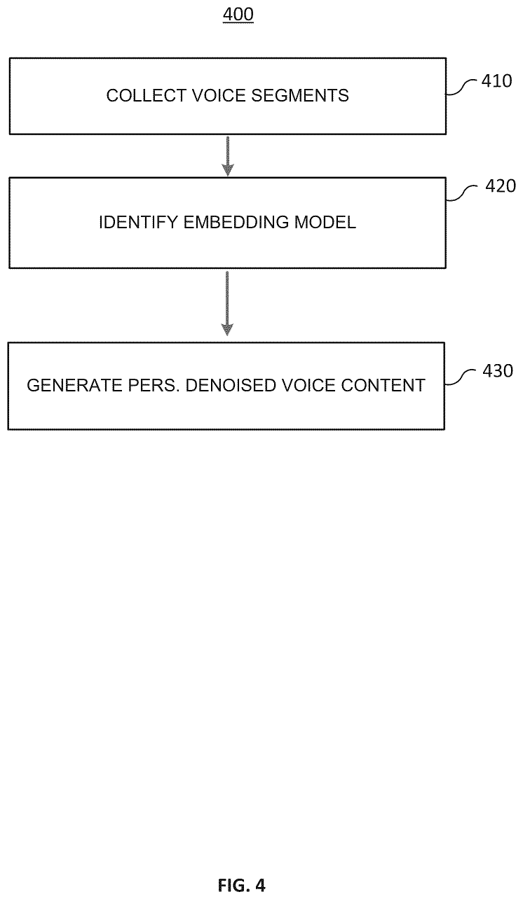

As shown in the flowchart diagram 400 of the example of FIG. 4, the Denoise Engine collects segments of voice content of a first user account from audio data associated with a virtual meeting. (Step 410). In some embodiments, an individual may access a virtual meeting via a first user account. Audio data associated with the virtual meeting may include voice content of the first user account and additional audio content. The additional audio content may be, for example, non-voice content, ambient audio content and/or additional voice content from other user accounts accessing the virtual meeting. The Denoise Engine may detect various segments of different types of additional audio content and discards those detected various segments in order to isolate respective voice content segments of the first user account.

The Denoise Engine identifies an audio embedding model based on the first user account. (Step 420) The first user account may be associated with a particular audio embedding model. Each respective user account may be associated with its an audio embedding model. That is, an audio embedding model will be specific to a respective user account or a plurality of user accounts may be associated with the same audio embedding model. The Denoise Engine generates the particular audio embedding model for the first user account based on implementing an artificial intelligence (or deep-learning) algorithm(s) that receives various audio samples of the first user account as training data input. It is understood that generation of an audio embedding model may be initiated and/or completed prior to the virtual meeting.

The Denoise Engine generates personalized denoised voice content of the first user account for the virtual meeting by applying the audio embedding model to the collected segments of the voice content. (Step 430) The audio embedding model returns speaker embeddings 320 based on one or more of the respective voice content segments of the first user account. Denoise Engine may filter the speaker embeddings 320 of the first user account according to a segment similarity criteria. Upon filtering speaker embeddings 320 of the first user's voice content to identify a group of speaker embeddings 320 that each meet a similarity threshold, the Denoise Engine determines an average speaker embedding based on the group of speaker embeddings 320. The Denoise Engine feeds the speaker embedding 320 (i.e. the average speaker embedding) into a personalized denoise model 330. The personalized denoise model 330 returns denoised audio output 340.

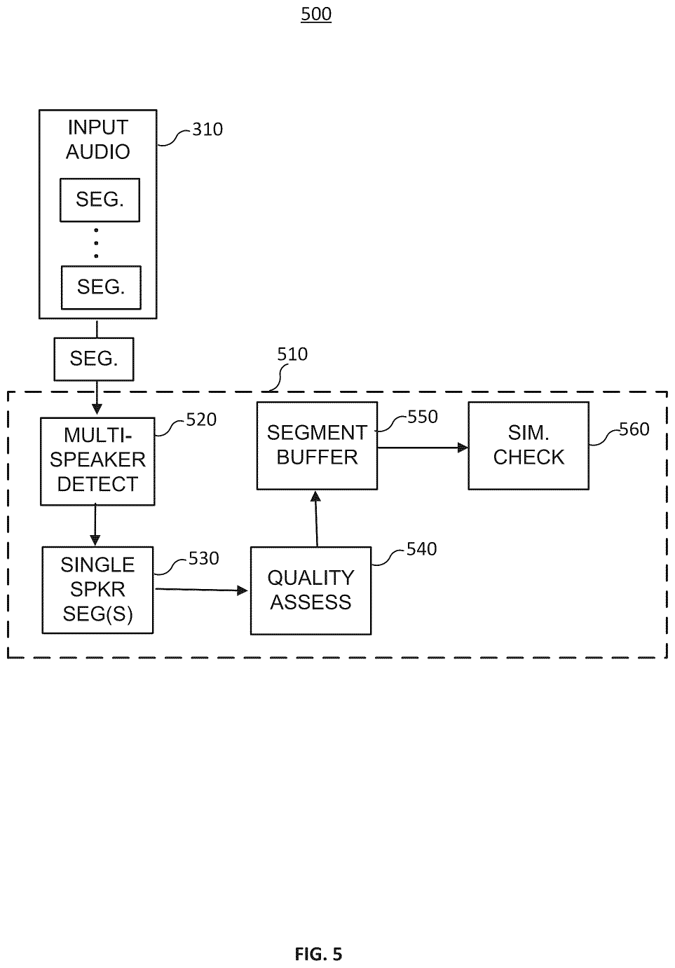

As shown in diagram 500 of the example of FIG. 5, the Denoise Engine implements collection 510 of voice content segments prior to initiating a similarity check 560. The Denoise Engine receives input audio 310 and verifies the particular type of audio capture device in use by first user account during the virtual meeting. Upon verification that the particular type of audio capture device is a preferred type of audio capture device, the Denoise Engine initiates collection of the segments of voice content of the first user account from audio data 310 associated with a virtual meeting. For example, the Denoise Engine may enforce a requirement that audio data provided from the first user account must be captured by microphone(s) of a headset device (and/or any other type(s) of pre-defined audio capture device) in order to trigger initiation of voice content collection.

The Denoise Engine implements multi-speaker detection 520 in order to determine whether voice content of the first user account includes ambient audio content and/or other types of audio content. For example, ambient audio content may be associated with a current physical location of the individual accessing the virtual meeting via the first user account. The ambient audio content may represent a voice(s) of a speaker(s) who is a different individual(s) physically located at a certain distance away from the individual accessing the virtual meeting via the first user account. As such, the ambient audio content may be perceived in the audio data 310 of the virtual meeting as audio interference of the actual voice content of the first user account (i.e. audio of the speaker's voice). For example, the ambient audio content may be perceived as representing sounds made by (or spoken by) various other individuals physically near the individual accessing the virtual meeting via the first user account.

The Denoise Engine identifies single speaker segments 530 of voice content of the first user account. The Denoise Engine determines when voice content segments in the audio data 310 have one or more spectrogram features that represent sounds of multiple speakers. The Denoise Engine discards those multi-speaker voice content segments. In addition, the Denoise Engine identifies and discards non-voice content segments. The Denoise Engine identifies audio segments in the audio data 310 that correspond with one or more spectrogram features indicative of non-voice data. The Denoise Engine discards any identified non-voice content segments as well.

After collecting single speaker voice content segments 530 of the first user account, the Denoise Engine runs a quality assessment 540 check on the collected segments 530. In some embodiments, the Denoise Engine may feed the collected segments 530 as input into a deep-learning quality scoring model. For example, the deep-learning quality scoring model may be a deep noise suppression mean opinion scoring (DNSMOS) model. The DNSMOS model returns a quality score of each input segment from the collected segments 530.

The Denoise Engines identifies respective single speaker voice content segments 530 that meet a quality threshold based on respective segment quality scores returned by the deep-learning quality scoring model. A segment(s) that meets the quality threshold is deemed as a high-quality segment by the Denoise Engine. The Denoise Engine places one or more of the high-quality scoring single speaker voice content segments 530 into a buffer 550. Upon detecting the high-quality voice content segments 530 currently stored in the buffer 550 satisfy a segment amount threshold, the Denoise Engine initiates a similarity check 560.

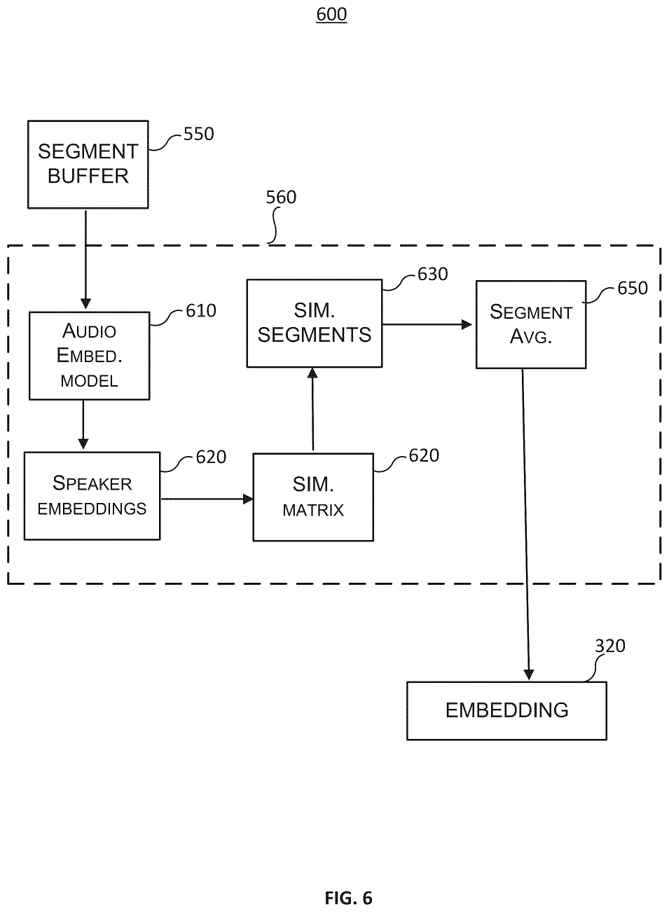

As shown in diagram 600 of the example of FIG. 6, the Denoise Engine implements a similarity check 560 on one or more of the high-quality voice content segments 530 currently stored in the buffer 550. Based on satisfaction of the buffer's 550 segment amount threshold, the Denoise Engine feeds one or more of the buffered high-quality voice content segments 530 into an audio embedding model 610 specific to the first user account.

The audio embedding model 610 returns audio embedding information for each segment fed into the audio embedding model 610 from the buffer 550. The Denoise Engine generates a similarity matrix 620 based on one or more of the segment embeddings. In some embodiments, the Denoise Engine generates a vector representation of each segment embedding for the similarity matrix 620 and determines a group of similar segment embeddings 630 based on comparisons of the vector representations. For example, a comparison of two vector representations by the Denoise Engine that falls within a similarity threshold range may be flagged as corresponding to similar audio embeddings. That is, a comparison of two vector representations that returns a value within an exemplary similarity threshold range defined as being between 0 to 0.15 results in identifying those two vector representations as similar vector representations. Stated another way, if the absolute value of a difference between two vector representations is greater than 0 and less than 0.15 (i.e. within the exemplary similarity threshold range), the Denoise Engine deems those two vector representations as similar to each other. In some embodiments, the Denoise Engine determines that comparisons of some of the segment embeddings do not satisfy the similarity threshold range. As an example, the Denoise Engine may determine that not all comparisons of the segment embeddings fall within the similarity threshold range. For example, the Denoise Engine determines that a subset of comparisons of the segment embeddings are not within the 0 to 0.15 exemplary similarity threshold range. In such a case, failure of one or more of the comparisons to qualify within the similarity threshold range indicates a likelihood that background speaking, represented in ambient audio content, may be from one or more other individuals currently located proximate to the individual represented by the first user account. The failure for one or more segment embedding comparisons to meet the 0 to 0.15 similarity threshold range triggers the Denoise Engine to initiate an operation to bypass use of the personalized denoise model 330 due to a concern that the other individuals are seated too close to the individual represented by the first user account. By likely being seated too close to the individual represented by the first user account, the buffer 550 likely includes high-quality voice content for those other individuals, which represents a significant risk of high audio interference. The possibility of the significant risk of high audio interference negates the appropriateness of utilizing the personalized denoise model 330. It is understood that, in various embodiments, the similarity threshold range is not limited to being defined as being within 0 to 0.15. In some embodiments, another exemplary similarity threshold range may be defined as being between 0-0.1 that corresponds to a strict trigger for Denoise Engine to feed the personalized denoise model 330—as opposed to bypassing the personalized denoise model 330.

The Denoise Engine determines an average segment embedding 650 based on the vector representations grouped as similar audio embeddings 630. The Denoise Engine feeds the average segment embedding 650 as an embedding 320 that will be input into the personalized denoise model 330.

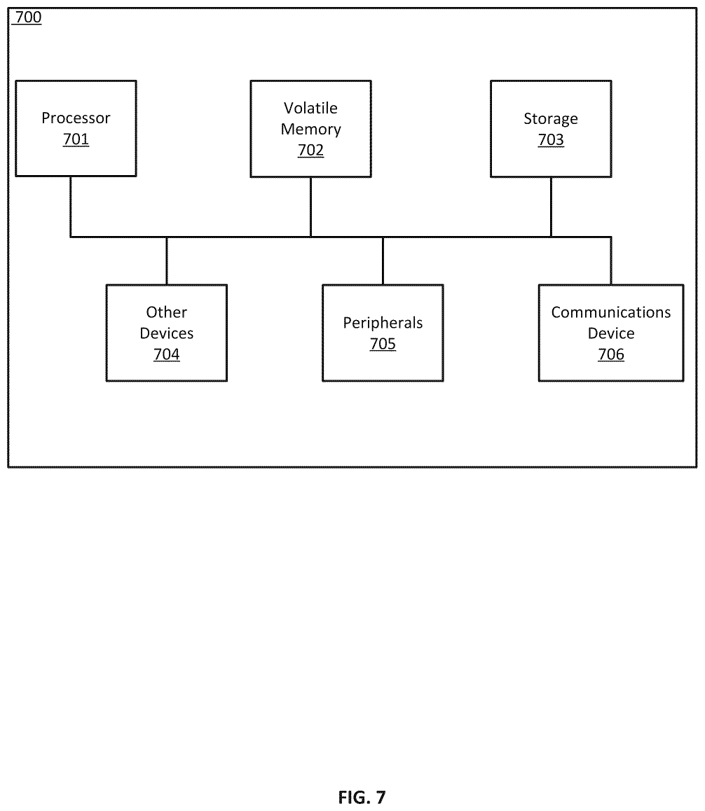

FIG. 7 is a diagram illustrating an exemplary computer that may perform processing in some embodiments. As shown in the example of FIG. 7, an exemplary computer 700 may perform operations consistent with some embodiments. The architecture of computer 700 is exemplary. Computers can be implemented in a variety of other ways. A wide variety of computers can be used in accordance with the embodiments herein.

Processor 701 may perform computing functions such as running computer programs. The volatile memory 702 may provide temporary storage of data for the processor 701. RAM is one kind of volatile memory. Volatile memory typically requires power to maintain its stored information. Storage 703 provides computer storage for data, instructions, and/or arbitrary information. Non-volatile memory, which can preserve data even when not powered and including disks and flash memory, is an example of storage. Storage 703 may be organized as a file system, database, or in other ways. Data, instructions, and information may be loaded from storage 703 into volatile memory 702 for processing by the processor 701.

The computer 700 may include peripherals 705. Peripherals 705 may include input peripherals such as a keyboard, mouse, trackball, video camera, microphone, and other input devices. Peripherals 705 may also include output devices such as a display. Peripherals 705 may include removable media devices such as CD-R and DVD-R recorders/players. Communications device 706 may connect the computer 700 to an external medium. For example, communications device 706 may take the form of a network adapter that provides communications to a network. A computer 700 may also include a variety of other devices 704. The various components of the computer 700 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computer device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general-purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

It will be appreciated that the present disclosure may include any one and up to all of the following examples.

Example 1: A computer-implemented method comprising: collecting one or more segments of voice content of a first user account from audio data associated with a virtual meeting, the audio data further including additional audio content; identifying an audio embedding model; receiving a speaker embedding generated by the audio embedding model, the speaker embedding based on the one or more collected segments of voice content; and generating personalized denoised voice content of the first user account for the virtual meeting by applying the speaker embedding to the audio data associated with a virtual meeting.

Example 2: The method of Example 1, further comprising: wherein collecting one or more segments of voice content of the first user account comprises: detecting respective segments of the additional audio data; capturing respective segments of voice content of the first user account by discarding the detected segments of the additional audio data; and filtering the respective segments of voice content of the first user account according to a segment similarity criteria.

Example 3: The method of any Examples 1-2, further comprising: wherein generating personalized denoised voice content of the first user account comprises: sending input to the audio embedding model based on one or more filtered respective similar segments of voice content.

Example 4: The method of any Examples 1-3, further comprising: wherein the additional audio content comprises: ambient audio content associated with a current physical location of an individual accessing the virtual meeting via the first user account.

Example 5: The method of any Examples 1-4, further comprising: wherein the additional audio content comprises: voice content different than the voice content of the first user account.

Example 6: The method of any Examples 1-5, further comprising: wherein the voice content of the first user account comprises: voice content in the audio data captured by a pre-defined audio capture device currently in use by an individual accessing the virtual meeting via the first user account; and based on verifying current use of the pre-defined audio capture device, initiating collection of the one or more segments of voice content of the first user.

Example 7: The method of any Examples 1-6, further comprising: wherein the pre-defined audio capture device comprises at least one microphone disposed on a headset device.

Example 8: A non-transitory computer-readable medium having a computer-readable program code embodied therein to be executed by one or more processors, the program code including instructions for: collecting one or more segments of voice content of a first user account from audio data associated with a virtual meeting, the audio data further including additional audio content; identifying an audio embedding model; receiving a speaker embedding generated by the audio embedding model, the speaker embedding based on the one or more collected segments of voice content; and generating personalized denoised voice content of the first user account for the virtual meeting by applying the speaker embedding to the audio data associated with a virtual meeting.

Example 9: The non-transitory computer-readable medium of Example 8, further comprising: wherein collecting one or more segments of voice content of the first user account comprises: detecting respective segments of the additional audio data; capturing respective segments of voice content of the first user account by discarding the detected segments of the additional audio data; grouping the respective segments of voice content of the first user account in a buffer; and filtering the buffered respective segments of voice content of the first user account according to a segment similarity criteria.

Example 10: The non-transitory computer-readable medium of any Examples 8-9, further comprising: wherein filtering the buffered respective segments of voice content comprises: filtering the respective segments of voice content upon determining a current amount of buffered segments meets a threshold amount.

Example 11: The non-transitory computer-readable medium of any Examples 8-10, further comprising: wherein generating personalized denoised voice content of the first user account comprises: sending input to the audio embedding model based on one or more filtered respective similar segments of voice content.

Example 12: The non-transitory computer-readable medium of any Examples 8-11, further comprising: wherein the additional audio content comprises: ambient voice content associated with a current physical location of an individual accessing the virtual meeting via the first user account, the ambient voice content different than the voice content of the first user account.

Example 13: The non-transitory computer-readable medium of any Examples 8-12, further comprising: wherein the voice content of the first user account comprises: voice content in the audio data captured by a pre-defined audio capture device currently in use by an individual accessing the virtual meeting via the first user account; and based on verifying current use of the pre-defined audio capture device, initiating collection of the one or more segments of voice content of the first user.

Example 14: A communication system comprising one or more processors configured to perform the operations of: collecting one or more segments of voice content of a first user account from audio data associated with a virtual meeting, the audio data further including additional audio content; identifying an audio embedding model; receiving a speaker embedding generated by the audio embedding model, the speaker embedding based on the one or more collected segments of voice content; and generating personalized denoised voice content of the first user account for the virtual meeting by applying the speaker embedding to the audio data associated with a virtual meeting.

Example 15: The communication system of Example 14, further comprising: wherein collecting one or more segments of voice content of the first user account comprises: detecting respective segments of the additional audio data; capturing respective segments of voice content of the first user account by discarding the detected segments of the additional audio data; and filtering the respective segments of voice content of the first user account according to a segment similarity criteria.

Example 16: The communication system of any Examples 14-15, further comprising: wherein filtering the respective segments of voice content comprises: grouping the respective segments of voice content of the first user account in a buffer; and filtering the respective segments of voice content upon determining a current amount of buffered segments meets a threshold amount.

Example 17: The communication system of any Examples 14-16, further comprising: wherein generating personalized denoised voice content of the first user account comprises: sending input to the audio embedding model based on one or more filtered respective similar segments of voice content.

Example 18: The communication system of any Examples 14-17, further comprising: wherein the additional audio content comprises at least one of: non-voice content and additional voice content different than the voice content of the first user account.

Example 19: The communication system of any Examples 14-18, further comprising: wherein the additional voice content comprises: ambient voice content associated with a current physical location of an individual accessing the virtual meeting via the first user account.

Example 20: The communication system of any Examples 14-19, further comprising: verifying current use of a pre-defined audio capture device by the first user account; based on the verification, initiating collection of the one or more segments of voice content of the first user.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method comprising:
collecting one or more segments of voice content of a first user account from audio data associated with a virtual meeting, the audio data further including additional audio content;
identifying an audio embedding model;
receiving a speaker embedding generated by the audio embedding model, the speaker embedding based on the one or more collected segments of voice content; and
generating personalized denoised voice content of the first user account for the virtual meeting by applying the speaker embedding to the audio data associated with a virtual meeting.

2. The computer-implemented method of claim 1, wherein collecting one or more segments of voice content of the first user account comprises:
detecting respective segments of the additional audio data;
capturing respective segments of voice content of the first user account by discarding the detected segments of the additional audio data; and
filtering the respective segments of voice content of the first user account according to a segment similarity criteria.

3. The computer-implemented method of claim 2, wherein generating personalized denoised voice content of the first user account comprises:
sending input to the audio embedding model based on one or more filtered respective similar segments of voice content.

4. The computer-implemented method of claim 1, wherein the additional audio content comprises: ambient audio content associated with a current physical location of an individual accessing the virtual meeting via the first user account.

5. The computer-implemented method of claim 1, wherein the additional audio content comprises: voice content different than the voice content of the first user account.

6. The computer-implemented method of claim 1, wherein the voice content of the first user account comprises: voice content in audio data captured by a pre-defined audio capture device currently in use by an individual accessing the virtual meeting via the first user account; and
based on verifying current use of the pre-defined audio capture device, initiating collection of the one or more segments of voice content of the first user.

7. The computer-implemented method of claim 6, wherein the pre-defined audio capture device comprises at least one microphone disposed on a headset device.

8. A non-transitory computer-readable medium having a computer-readable program code embodied therein to be executed by one or more processors, the program code including instructions for:
collecting one or more segments of voice content of a first user account from audio data associated with a virtual meeting, the audio data further including additional audio content;
identifying an audio embedding model;
receiving a speaker embedding generated by the audio embedding model, the speaker embedding based on the one or more collected segments of voice content; and
generating personalized denoised voice content of the first user account for the virtual meeting by applying the speaker embedding to the audio data associated with a virtual meeting.

9. The non-transitory computer-readable medium of claim 8, wherein collecting one or more segments of voice content of the first user account comprises:
detecting respective segments of the additional audio data;
capturing respective segments of voice content of the first user account by discarding the detected segments of the additional audio data;
grouping the respective segments of voice content of the first user account in a buffer; and
filtering the buffered respective segments of voice content of the first user account according to a segment similarity criteria.

10. The non-transitory computer-readable medium of claim 9, wherein filtering the buffered respective segments of voice content comprises:
filtering the respective segments of voice content upon determining a current amount of buffered segments meets a threshold amount.

11. The non-transitory computer-readable medium of claim 9, wherein generating personalized denoised voice content of the first user account comprises:
sending input to the audio embedding model based on one or more filtered respective similar segments of voice content.

12. The non-transitory computer-readable medium of claim 8, wherein the additional audio content comprises: ambient voice content associated with a current physical location of an individual accessing the virtual meeting via the first user account, the ambient voice content different than the voice content of the first user account.

13. The non-transitory computer-readable medium of claim 8, wherein the voice content of the first user account comprises: voice content in audio data captured by a pre-defined audio capture device currently in use by an individual accessing the virtual meeting via the first user account; and
based on verifying current use of the pre-defined audio capture device, initiating collection of the one or more segments of voice content of the first user.

14. A communication system comprising one or more processors configured to perform the operations of:
collecting one or more segments of voice content of a first user account from audio data associated with a virtual meeting, the audio data further including additional audio content;
identifying an audio embedding model;
receiving a speaker embedding generated by the audio embedding model, the speaker embedding based on the one or more collected segments of voice content; and
generating personalized denoised voice content of the first user account for the virtual meeting by applying the speaker embedding to the audio data associated with a virtual meeting.

15. The communications system of claim 14, wherein collecting one or more segments of voice content of the first user account comprises:
detecting respective segments of the additional audio data;
capturing respective segments of voice content of the first user account by discarding the detected segments of the additional audio data; and
filtering the respective segments of voice content of the first user account according to a segment similarity criteria.

16. The communications system of claim 15, wherein filtering the respective segments of voice content comprises:
grouping the respective segments of voice content of the first user account in a buffer; and
filtering the respective segments of voice content upon determining a current amount of buffered segments meets a threshold amount.

17. The communications system of claim 15, wherein generating personalized denoised voice content of the first user account comprises:
sending input to the audio embedding model based on one or more filtered respective similar segments of voice content.

18. The communications system of claim 14, wherein the additional audio content comprises at least one of: non-voice content and additional voice content different than the voice content of the first user account.

19. The communications system of claim 18, wherein the additional voice content comprises:
ambient voice content associated with a current physical location of an individual accessing the virtual meeting via the first user account.

20. The communications system of claim 14, further comprising:
verifying current use of a pre-defined audio capture device by the first user account;
based on the verification, initiating collection of the one or more segments of voice content of the first user.
